(19) United States
(12) Patent Application Publication
(10) Pub. No.: US 2013/0077817 A1
(43) Pub. Date: Mar. 28, 2013

(54) STEGANOGRAPHIC METHOD

(71) Applicants: Avraham Naparstek, Raanana (IL); Dorit Naparstek, Tel Aviv (IL); Jacob Naparstek, Kfar Saba (IL)

(72) Inventors: Avraham Naparstek, Raanana (IL); Dorit Naparstek, Tel Aviv (IL); Jacob Naparstek, Kfar Saba (IL)

(73) Assignee: CARDYGEN LTD., Kfar Saba (IL)

(21) Appl. No.: 13/702,761

(22) PCT Filed: Jun. 1, 2011
(86) PCT No.: PCT/IL11/00428

§ 371 Date: Dec. 7, 2012

Related U.S. Application Data
(60) Provisional application No. 61/352,838, filed on Jun. 9, 2010.

(51) Int. Cl. G06T 1/00

(52) U.S. Cl. CPC G06T 1/0021
USPC 382/100

(57) ABSTRACT

A steganographic method is presented that provides authentication of user identity, such that only an authorized user may reveal the data hidden steganographically. Two data objects such as images are used for this purpose, one hidden within the other. A key provision of the invention allows the ‘inner’ image to itself contain hidden data that is not corrupted by subsequent compression within the ‘outer’ image. A digital ‘scratch card’ is by this means implemented, where the inner image is only revealed to an authorized user. Using this algorithm, physical cards containing data are represented by a single digital object.

### FIELD OF THE INVENTION

The present invention relates to a device and method for embedding information in files and related steganographic methods.

### BACKGROUND OF THE INVENTION

In certain situations it is of interest to transmit information that is hidden from plain view. For example, the use of scratch cards is common for distribution of prizes. A customer for instance receives a scratch card from a vendor with every purchase. The scratch card contains hidden information in the form of (for example) a picture or set of pictures covered by a removable layer of pigment or metal foil. If this picture or pictures meet certain criteria the card holder is entitled to benefits such as a free meal, lottery monies, or the like.

Such use of ‘hidden writing’ is more formally referred to as steganography, a field which includes the aforementioned scratch cards as well as more sophisticated variants such as the embedding of information in the least significant bits: of JPG-encoded pictures, audio files, or the like. In these latter cases the information being transmitted is digital in nature, and is often so well hidden that files may be transferred from user to user without their knowledge that in fact a hidden message is being transmitted.

Billions of scratch cards are used worldwide every year for many purposes. Gaming, promotions, prepaid and gifts cards are only partial list of scratch cards use cases.

Digital, scratch cards have been implemented using. Web 2.0 Rich Internet Application (RIA) technologies. No matter what RIA technology is used, the scratch card always remains on the server side, and the user redeems the scratch card either by: 1) printing out a hardcopy of winning card, and presenting this hardcopy at a point of sale for redemption, or 2) interacting with the user's account through a virtual or online bank account, which can credit or debit user accounts based on the scratch card information. However there are certain implementation considerations that such methods fail to consider.

Hence, an improved method for digital implementation of a scratch-card or equivalent digital object is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents a general flowchart of the encryption and verification methods of the invention;

FIG. 2 presents one embodiment of a scratch-card image on a smart phone;

FIG. 3 presents a detailed flowchart of the encryption method of the invention

FIG. 4a-e present hidden and revealed images processed by the method of the invention;

FIG. 5 presents a flowchart depicting the decryption method of the invention;

FIG. 6 presents a flowchart describing the user actions for implementation of the invention;

FIG. 7 presents a flowchart describing user registration;

FIG. 8 presents an overall flowchart describing operation of the invention;

FIG. 9 presents a flowchart describing the process of revealing hidden data;

FIG. 10 presents a flowchart describing redemption of a winning card;

FIG. 11 present a flowchart describing the validation steps of the invention;

FIG. 12 presents in prior art a jpeg steganographic method using DCT coefficients.

### SUMMARY OF THE INVENTION

The present invention comprises a system and method for generation, transfer, and use of hidden information, implemented in one embodiment as a digital scratch card system and method, and in some embodiments as a scratch card protocol. Other implementations of the invention include admission tickets, entry cards, membership cards, discount cards, coupons, debit cards, food stamps, ecash, and credit cards.

The hidden information involved may be transmitted for instance on mobile devices such as cellphones. It is within provision of the invention to produce, manage and dispatch digital scratch cards over a network of any type to users, either at request of a user trigger or by a system trigger.

It is within provision of the invention to provide a local device application (LDA) enabling the user to perform the digital equivalent of physically scratching off a section of a scratch card, revealing hidden data and subsequently enabling the user to redeem the card for various purposes, for example for cash back at a point-of-sale.

It is within provision of the invention to provide a protocol governing the embedding of hidden data within other data objects.

It is within the core of the present invention that a jpeg image be used to encode hidden data. It is further within provision of the invention that data be encoded in the least significant bits of the DCT transform coefficients of a jpeg image.

While the invention is susceptible to various modifications and alternative forms, specific embodiments thereof have been shown by way of example in the drawings and will herein be described in detail. It should be understood, however, that pit is not intended to limit the invention to the particular forms disclosed, but on the contrary, the intention is to cover; all modifications, equivalents, and alternatives falling within the spirit and scope of the invention as defined by the appended claims.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a steganographic method.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer e.g, 1, 5, or 10.

The term ‘smart phone’ refers hereinafter to a mobile phone offering advanced capabilities, having PC like functionality.

The term ‘scratch card’ refers to an object having hidden information that may be revealed by an on the part of the user of the smart card. The information generally concerns a promotion, coupon, lottery, game, gift, or information allowing the bearer to redeem the card for such. For example a scratch card may be distributed by a fast food company having pictures of various fast food products hidden under a removable metal foil. Buyers of certain products receive the cards with the metal foil intact and the pictures hidden. The recipient scratches off the foil to reveal fast food products for which the card may be redeemed. In the current invention, the scratch card is implemented digitally and hence is a digital object and not a physical card. The term scratch card includes such implementations as admission tickets, entry cards, membership cards, discount cards, coupons, debit cards, food stamps, ecash, and credit cards.

The term ‘DCT’ hereinafter refers to the discrete cosine transform.

The term ‘local device application’ or ‘LDA’ refers hereinafter to an application running locally on a smartphone, dumb terminal, or other node on a network that allows interaction with a user or users, typically being a smartphone or PC having internet connectivity.

The term ‘image based protocol’ refers hereinafter to a protocol of the invention that generally speaking inserts encoded information into files such as images or others, in such a manner that detection and/or decryption of this information is difficult or is possible only in NP (non-polynomial, generally speaking exponential or higher) time.

The term ‘compression’ refers hereinafter to any operation tending to decrease the total size of a file, in general losing some amount of data in the process. An example of a method compression is the jpeg compression algorithm, which uses a discrete cosine transform of controllable fidelity. The greater the compression, the lower the fidelity of the compressed file to the original.

The term ‘decompression’ refers hereinafter to the reverse of a compression operation, intended to extract a file from a compressed version thereof.

Current smart phones offer the user state-of-the-art technologies including computational power, improved user interfaces such as touch screens, smaller form factors, lower prices and expanded connectivity. Such phones are being increasingly employed for a number of transactions such as transfer of credit from person to person, identification, entrance into venues, bill payments, sundry purchases, and the like.

The system described in this disclosure enables a smart phone user (or other computer user) to obtain and use a ‘scratch card’ which may involve a promotion, coupon, lottery game, gift card, or donation, in a similar manner to a paper scratch card. The scratch card in its hidden state has no indication of certain hidden information content, while in its revealed state the hidden information is revealed to the user.

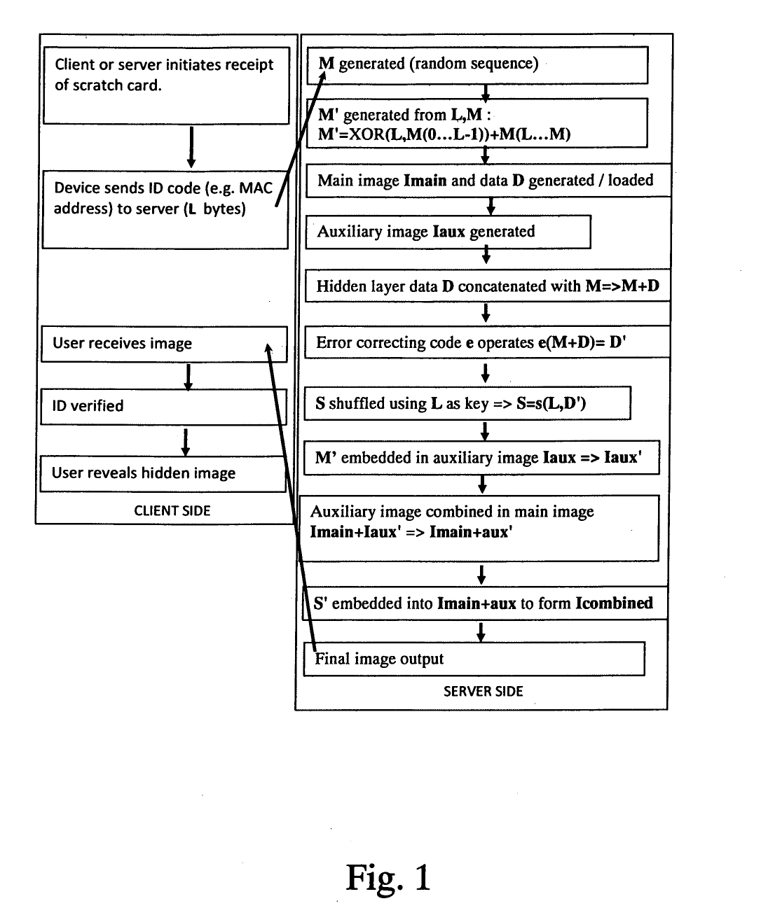

One embodiment of the invention follows these steps, as shown in FIG. 1:
1. [client side] Client or server initiates card generation
2. [client side] ID string L generated using a code/mac address etc.
3. [server side] Random sequence M is generated
4. [server side] M′ is generated from M,L: M′=XOR(L, M_{0 . . . L-1})+M_{L . . . M}
5. [server side] Main image Iₘₐᵢₙ generated from template
6. [server side] Auxiliary image Iₐᵤₓ created
7 [server side] Concatenate data to be hidden D with M=>M+D
8. [server side] Error correcting code performed M+D=>D′
9. [server side] Shuffle D′ using L as key=>S
10. [server side] Embed M′ in Iₐᵤₓ
11. [server side] Combine main and auxiliary images=>Iₘₐᵢₙ₊ₐᵤₓ
12. [server side] Embed S into Iₘₐᵢₙ₊ₐᵤₓ
13. [server side] Output image, send to client
14. [client side] Receive image
15. [client side] Verify client identity
16. [client side] Reveal hidden image

A more detailed explanation will be given in the section labeled “Data embedding in image”.

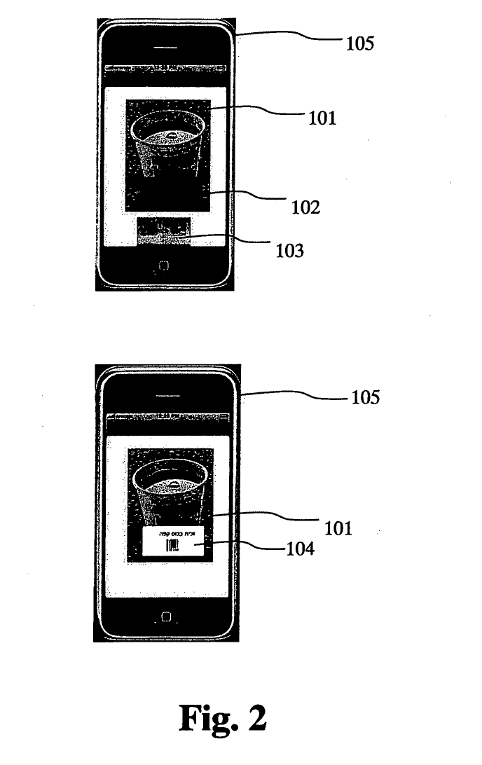

With reference to FIG. 2, an example of a digital scratch card is shown which may comprise a single jpeg image 101 containing embedded data, the jpeg image 101 being presented on a smartphone screen 105. The data associated with the scratch card is stored in a hidden form 102 within the image, until it is revealed (104) by means of an “Image based protocol”, which is a generic scalable binary protocol running on top of advanced robust image steganographic algorithms. An application running on the smartphone provides various interface options such as buttons 103, which allow the user to interact with the application, for instance to redeem a winning scratch card, forward a card, request a card, or the like. In one embodiment of the invention, the user performs a wiping or scratching motion on the obscured part of the image 102, in order to reveal the information hidden ‘underneath’ (104).

The algorithm of the invention allows the user who fulfills certain conditions, to ‘scratch’ the card (for example by physically mimicking the action of scratching an image on a smartphone touch screen), revealing a hidden image behind the scratched area. Once the hidden area is revealed, the user has read-only access to potentially useful hidden information, such as whether this is a winning card or not, a telephone number for further enquiry, a hyperlink, money transfer information, or the like.

Conditions allowing, the user to reveal the hidden information may include identification information, machine MAC address, transaction information, and the like.

It is important to note that the data cannot be accessed by the user, unless the device application is used. Thus a requirement of the method is that the image based protocol or IBP is the only method by which the hidden information can be accessed. The protocol enables a user to pass variable parameters to enable one device application for all scratch card types. Other applications are within provision of the invention such as admission tickets, membership cards, discount cards, coupons, debit cards, food stamps, ecash, and credit cards. Amongst various pieces of information that may be transmitted using the method are:
Marker bytes for Start of Data
Marker bytes for end of Data
Marker bytes for fields separator

A Generic Header is used for all types and may include the fields:
Version
Application Type

For the particular application of scratch cards, the following variable header fields may also included (some mandatory, some optional depending on the Card Sub-Type):
Card sub-type
Field Type (Text, Image, Link, Configuration)
Win/Lose image/text
Supported redemption interface
Redemption identifier
Owner ID
Expiration Date
Visible Data
Visible Data position
Unique Card ID

The above fields are examples only and it is within provision of the invention that other fields may also optionally be used.

The method by which information is hidden in the data object of the scratch card is now detailed.

### Image Based Protocol—Overview

The image based protocol (IBP) comprises methods of inserting data into an image (or generally speaking any file) in such a way that this data can be only be extracted and interpreted by use of they IBP. For the purposes of the following discussion, reference will be made to image files; however as will be understood by one skilled in the art, any file allowing some degree of compression may be employed.

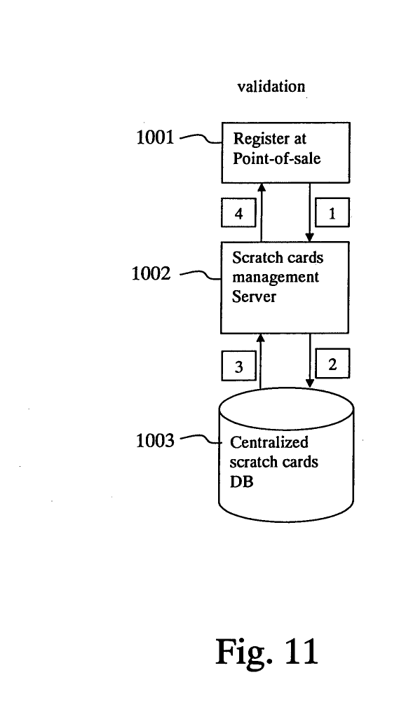

As is common for jpeg steganographic methods, an image containing data embedded by means of the IBP looks, to a human observer, exactly like an image without embedded data. Such algorithms may use for example the least significant bits of the discrete cosine transform used in jpeg compression, as shown in the prior art of FIG. 11. The device application, which implements a part of the IBP, is the only way to access the embedded data stored in the image, due to the authentication and security provisions of the IBP.

In certain embodiments of the invention a jpeg image is used to encode the hidden or embedded data, by use of the least significant bits of the DCT transform coefficients of the jpeg image involved, as will be described below.

Information of various sorts may be embedded. For example in the particular case of scratch cards the following fields may be provided:
Hidden image or text
Card Configuration
Supported redeem interfaces
Redeem identifier
Optional data associated to a Scratch card:
Owner Id
Expiration date
Visible commercial data
Visible commercial data display location
Hidden commercial data
Unique card id

### Data Embedding in Image—Algorithm Description

The IBP embeds data in an image in a highly robust manner, such that transmission errors and embedding/extraction steps (that may also include jpeg encoding/decoding) have a low probability of affecting the embedded data. Furthermore there is a vanishingly small probability that the embedded data can be revealed to or by unauthorized parties (e.g. by circumventing the authentication steps of the IBP). Finally, one may apply the embedding algorithm on the same image with different embedding data, many times.

The IBP utilizes two steps applied sequentially, each being a steganographic embedding. For example, the steps may be: (1) steganographic embedding in a color jpeg image, and (2) steganographic embedding in a binary (b/w) image. Alternatively, first the binary embedding method is applied, and afterwards the jpeg embedding method is applied to the image: as will be shown, the second embedding doesn't affect the information embedded by first step. As will be seen, the steps may both be of arbitrary color depth (i.e. 24 bpp color, 8 bpp grayscale, binary b/w, or otherwise) subject to certain constraints. In the case of non-image files similar provisions may be made mutatis mutandis, as will be obvious to one skilled in the art.

As an example of the method one first creates a binary image, in which one embeds auxiliary data. This data will also be used in the second embedding algorithm. Then one converts the binary image to a 24 bpp image and insert it into a subsection of the main 24 bpp image to form a combined image in which one embeds further data, using the second embedding algorithm.

The second algorithm doesn't influence the data embedded by the first one, by means that will be described below; in short, the second embedding algorithm uses a randomly varied quantization code for inserted data. In order to increase robustness and reduce unauthorized revealing of main data in the second algorithm, an error detection and correcting code is employed.

### Encoding

The specific encoding procedure is designed according to technical requirements the system operator can impose.

It is known that applying the jpeg embedding algorithm, in which one embeds data in the DCT coefficients, causes noise in the original data pixels of the image. The noise extends to the lower significant bits of the data pixels, generally being the least significant one, two or more bits depending on the algorithm, size of the image, and amount of data being embedded in the image.

In one embodiment of the encoding algorithm, the original main image consists of any image (for example at a color depth of 24 bpp) in which one replaces one or more fields (at a given location X₀, Y₀, and with a size A×B, pixels). The data pixels of the field(s) are quantized so that least significant bits (as many as one expects to be affected by noise) are set to their mid value, thus ensuring that the error introduced by any subsequent steps will not roll affect the bits being embedded by this first part of the algorithm. In the more significant bit planes of each of the color components (not affected by jpeg algorithm) one embeds data using the well known embedding algorithm in binary images.

Embedding data in the more significant bits of pixel data generally will cause significant noise in the image. By using the embedding algorithm in binary images one overcomes this limitation. By converting the auxiliary image in this example that is 1 bpp to a 24 bpp image, the pixel information which is black or white is now represented by ‘000000’ or ‘ffffff’. Noise that will be caused by the embedding algorithm in the combined image will not affect these values appreciably; by thresholding the pixel values the original values will be recovered.

The use of black/white(1 bpp) binary images are a special case for the algorithm. In this case one has only one bit plane. After embedding data, one converts it to full bit-depth image (e.g., 24 bpp) to replace the appropriate fields in the main image. In the following this special case is described; the general case is an obvious extension of this special case as will be clear to one skilled in the art.

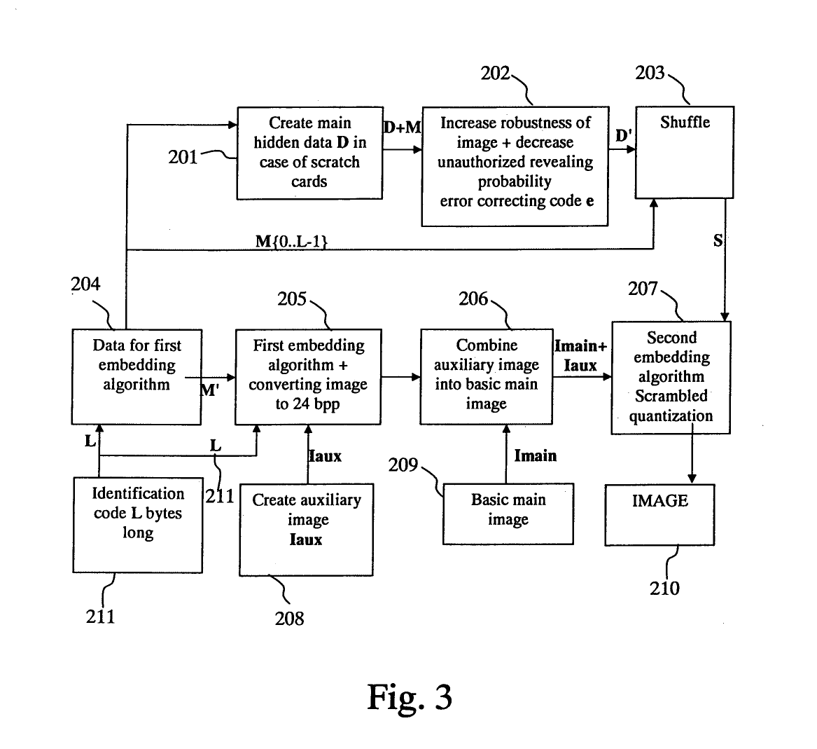

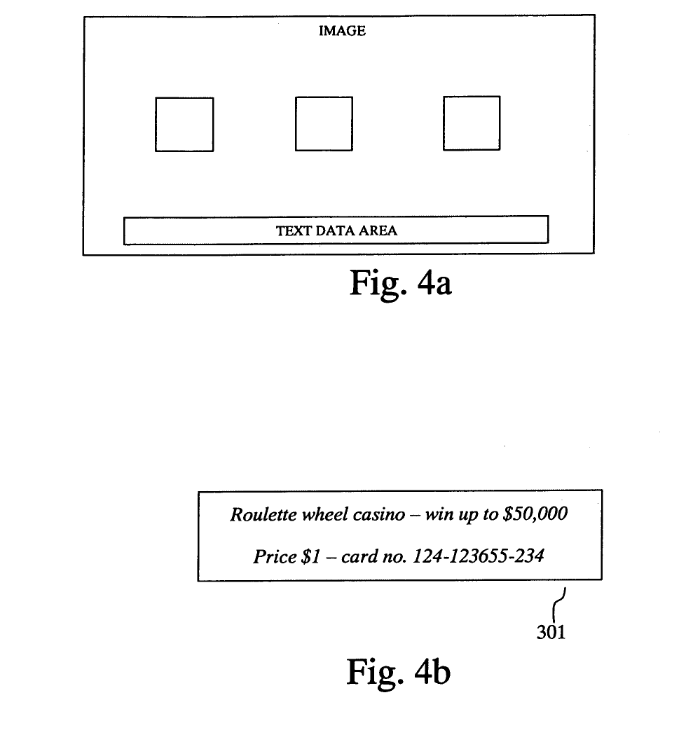

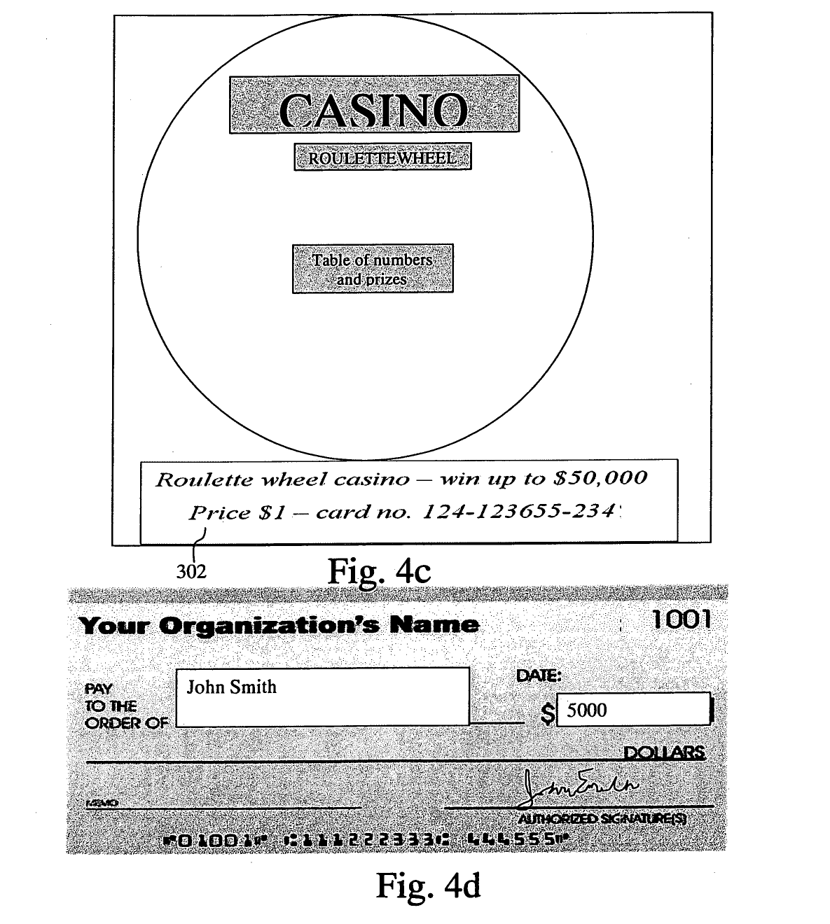

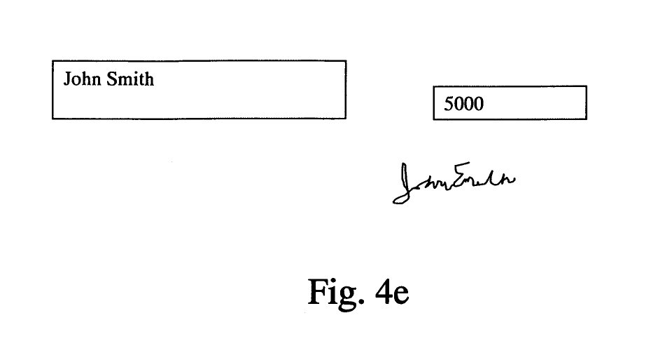

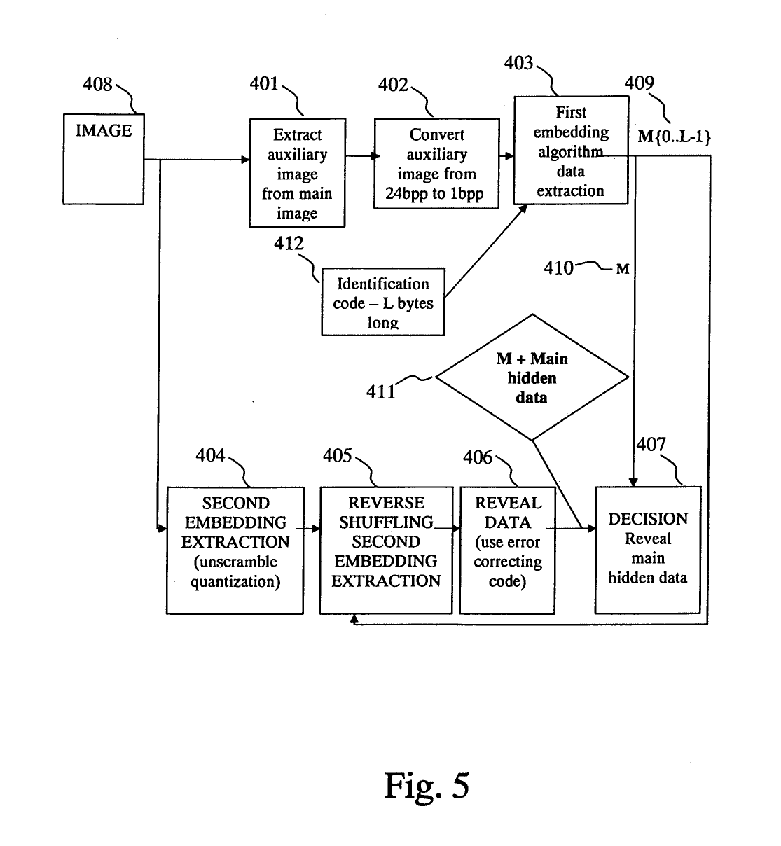

An example is now given of the operation of one embodiment of the IBP, illustrated in FIG. 3 and consisting of the following steps:
1. An identification code is determined (211). This is an L byte long code that belongs to the client (or is associated with an individual card) and is unique. This code is added to the embedded code M to distinguish between clients and/or cards. This may be any unique identifier such as a MAC address, personal ID, social security number, serial number, hardware identifier, timestamp, or combination of such identifiers. It is a feature of the method that the same results are returned for different runs using the same L-code.
2. Create data fields containing information used in the embedding algorithms, to be used during encoding/decoding (204). In this block one creates a random sequence of M bytes, in which M>L. The first L bytes of the random M bytes undergo the bitwise XOR operation. These bytes are denoted by K{0 . . . L−1}=L{0 . . . L−1} XOR M{0 . . . L-1}. One replaces the first L bytes in M with K to get M′.
3. Prepare data to embed. In the case of scratch cards, this is the data which will reveal the appropriate area on the image during scratching. In the case of digital cheques, some other data may be used. The data to be embedded D is concatenated to the M bytes of step 2 (block 204) to form D+M.
4. Use an error correcting code (202) e on the embedded data D+M to compute D′=e(D+M). As will be clear to one skilled in the art this increases the robustness of the jpeg embedding algorithm, for example preventing data corruption even if the image undergoes several subsequent jpeg encoding/decoding steps. It also decreases the probability of unauthorized revelation of the embedded data. It is well known that if the bit probability detection approaches ½, the use of coding will decrease the probability of the hidden data detection. As a result of using an error correcting code, the length of the data sequence will grow, depending on how many bits it can correct, how many bits to detect, and the robustness desired. It is within provision of the invention to use any known error correcting code for this step.
5. Shuffle the data (203) using the data output from the error correcting code (202). The data sequence from the error correcting code is bit by bit randomly shuffled to make it difficult to be extracted by an unauthorized person. One uses here the first L bytes of M sequence to parametrize the random shuffle function s, forming the shuffled sequence S=s(L,D′).
6. Create or obtain a binary (1 bpp) auxiliary image (208) that will be combined into the main image. (This image may actually be grayscale or 24 bpp or otherwise, binary being an example only). This image is for authentication and security purposes. The auxiliary image is one that the system operator designs, which is suitable for the application. The auxiliary image may comprise one or more fields. If this image has more than one field it means that during insertion of auxiliary image into main image each field is inserted in a different location in the main image. FIG. 4b and FIG. 4c show examples in which the auxiliary image consists of one field, and is therefore inserted in one location of main image (FIG. 4c). FIG. 4d and FIG. 4e show an example in which the auxiliary image (FIG. 4e) consists of 5 fields, and each is inserted in a different location in main image (FIG. 4d).
7. Embed the data M′ in the binary auxiliary image using first algorithm (205). Binary embedding algorithms for binary (b/w) images are well known. This procedure can be extended to general color (24 bpp or other bit depth) images or files. If one considers each bit plane separately as an independent binary image, then (for example) for a 24 bpp image there are 24 such individual bit planes. Each plane is here treated as a binary image. As mentioned above, the current example will describe the simplest case which is the binary b/w image, but the generalization to any color depth will be obvious to one skilled in the art. The content that one embeds is the M′ byte sequence (generated in block 204). One of the steps for embedding into the auxiliary image is a bit shuffle of the image. For the bit shuffle in the binary embedding algorithm one uses the L bytes sequence (generated in block 211) to control the shuffling sequence. Since one must insert this auxiliary image with embedded data as part of the main image that is a 24 bpp image, one first converts the binary 1 bpp b/w to 24 bpp b/w. As will be obvious to one skilled in the art, if the auxiliary image has a different bit depth it may be converted as necessary.
8. The next step for embedding into the auxiliary image involves using blocks of the shuffled auxiliary image. In each block, there will generally be some white and some black pixels (due to the random shuffling of the previous step). Thus the parity of the block (the sum of all pixels modulo 2) can be changed, by flipping a single pixel. Information is encoded into the parity of the blocks, by flipping (if necessary) a single pixel of the block. Each block thus encodes a single bit of information in its parity.
9. Get (create or obtain) the basic main 24 bpp image (209). The main 24 bpp image is designed by the system operator for the specific card or application. It is into this image that the auxiliary image will be inserted, in the manner of FIG. 4b being inserted into a part of FIG. 4c.
10. Combine the 24 bpp auxiliary image into the basic main 24 bpp image to get the main image (206). One uses here two images the basic main image in which the auxiliary image will be inserted. There are two cases as explained in paragraph 7 above.
11. Embed the data created in block 203 in the composite image created (in block 206), using the second embedding algorithm, with a quantization code that changes randomly during data embedding (207). This embedding may for instance be the JPEG embedding algorithm with scrambled quantization, although, it is within provision of the invention to use other steganographic methods. One uses here the shuffled data from block (203) with the combined image block (206). The JPEG embedding algorithm in which one embeds data in the quantized DCT coefficients is well known. The data can be inserted in one, two, or more of the lowest significant bits of the DCT coefficients. There is a tradeoff between the robustness and detection limits for such methods: as one uses fewer bits, the noise added to image will be lower, but at the same time the embedded data is less robust against further compression (or other noise introduction) such as jpeg coding/decoding steps. Such further encoding may cause errors in the embedding data, if not enough bits of the DCT have been used for the second embedding. As more significant embedded bits are used, so will there be less probability of errors due to subsequent jpeg encoding (or other noise introduction). By ‘scrambled quantization’ one means here that the code one uses for embedded bits ‘0’ and bit ‘1’ changes randomly. For example if one chooses to insert bit ‘0’ and ‘1’ in the three lowest bits of the DCT quantized coefficient first one will quantize the DCT coefficient by taking the integer part of the coefficient divided by 8 (three least significant bits are zero). Then one can assign the following values to the three least significant bit to represent ‘0’ or ‘1’ with maximum distance between assignments.

TABLE 1
encoding

| Entry | ‘0’ | ‘1’ |
|---|---|---|
| 0 | 000 | 100 |
| 1 | 001 | 101 |
| 2 | 010 | 110 |
| 3 | 011 | 111 |
| 4 | 100 | 000 |
| 5 | 101 | 001 |
| 6 | 110 | 010 |
| 7 | 111 | 011 |

TABLE 2
decoding

| Entry | ‘0’ | ‘1’ |
|---|---|---|
| 0 | 000, 001, 010, 111 | 100, 011, 101, 110 |
| 1 | 001, 000, 010, 011 | 101, 100, 110, 111 |
| 2 | 010, 001, 011, 100 | 110, 101, 111, 000 |
| 3 | 011, 010, 100, 101 | 111, 110, 000, 001 |
| 4 | 100, 011, 101, 110 | 000, 111, 001, 010 |
| 5 | 101, 100, 110, 111 | 001, 000, 010, 011 |
| 6 | 110, 101, 111, 000 | 010, 001, 011, 100 |
| 7 | 111, 110, 000, 001 | 011, 010, 100, 101 |

Each time one assigns a value ‘0’ or ‘1’ from shuffled data one chooses randomly a value from a table such as table 1. If the shuffled data length is smaller than the amount of data one can embed, one uses data from a pseudorandom function with a certain seed. The random function for selecting an entry from a table such as table 1 is preferably such that an even distribution of entries from the above table is used, thus eliminating any ‘fingerprints’ in the histogram of these data.

In the decoding step, one finds the value from the decoding table 2 by finding in which group a three bit sequence (in this example) falls—for example the sequence 010 occurs in entry 0 as value 0, thus the value for 010 is 0. In this way one recovers the original information hidden by use of table 1. The entries are found by using the same pseudorandom function as used in the encoding step, with the same seed—such that the same pseudorandom sequence is generated. One can use here, for distance value of one (1), a general but more complicated algorithm with a different number of words, not necessarily a power of 2, instead of the above simple example that uses eight (8) words for the data insertion in quantized dct coefficients. If the data D may take. K different values (in the above examples, K being 8), and is encoded in a number allowing X possible values, then the general algorithm uses

$${Q}_{k} ( x ) = K ⌊ \frac{x}{K} ⌋$$

where the standard notation

$$⌊ \frac{x}{K} ⌋$$

denotes the ‘floor’ of x/K, namely the larger integer less than or equal to x/K. Then the data is encoded as x_{d}=Q_{K}(x)+d. In the general case there are several ways to prevent overflow, such as by using x′=xM/255+N in which N=K−1 and M=255−2(K−1), and encoding the data as x_{d}=Q_{K}(x′)+d/
12. Get the image to be sent to user (210). At this point the steganography is done, the image is ready to be used our application.

It is possible to also use different schemes for step 10. of the encoding sequence above; in particular, one may use an error correcting code as in step 4. to more efficiently prevent any noise from corrupting the embedded data. As pointed out previously, since the auxiliary image is encoded with more bit depth than necessary for its actual color depth, a certain ‘information overhead’ exists in which hidden data may be embedded. In particular, if the actual bit depth (in this example 24 bpp) is larger than the actual color depth (in this example 1 bpp) then the difference (in this example 23 bpp) is available to make the auxiliary image less susceptible to noise caused by the second embedding algorithm. The larger this overhead, the less likely the information stored therein is to be corrupted by subsequent error-introducing steps such as compression.

In step 207 other embedding methods may be used, for example use of least significant bits of the picture to store data. These two compression steps must be ‘orthogonal’ in the sense that the two steps are invertible: one can state this condition as follows. The first compression step (205) is denoted by

A′=C₁(A),

where A is the original image (binary in this example), C is the compression function, and A′ the compressed image. The second compression step (207) is denoted

B′=C₂(B)

This second image B is itself a function of the first image A′ and another image I:

B=f(A′,I)

The requirement that the second compression step C₂ does not affect data embedded by the first step may be restated as a requirement that the function C₂ be invertible (as well as the original compression C₁). If C₂ is invertible, then the original image may be found by using the ‘unembedding’ inverse functions, A′=f¹(C₂(f(A′,I)) These steps will be more fully detailed below.

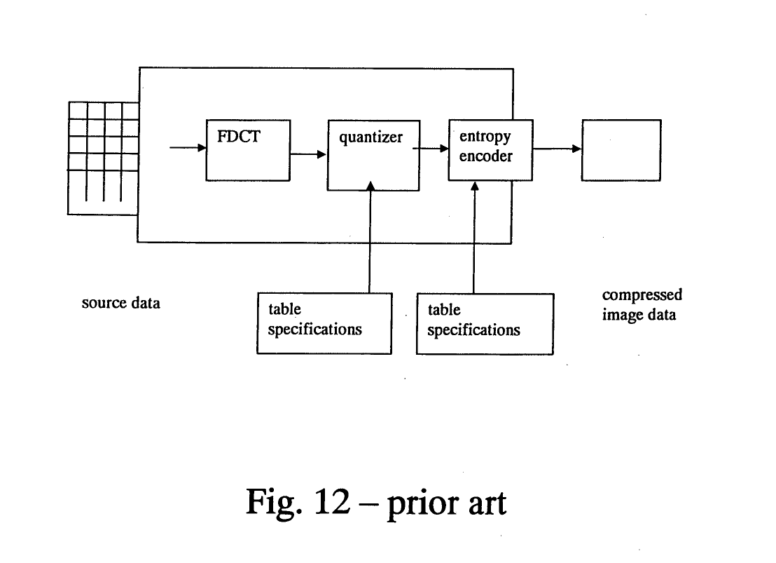

The embedding methods referred to may be standard steganographic embeddings such as the LSB (least significant bit) encoding into DCT coefficients, shown in FIG. 12. However it is within provision of the invention to use other steganographic methods, as will be clear to one skilled in the art.

### Decoding

The process of decoding is basically the inverse of the encoding process, with the final result ensured due to the inevitability of the second encoding step as described above. The steps consist of:
1. Reveal auxiliary image
2. Extract the auxiliary image from the main image (401).
3. Extract auxiliary image. The auxiliary image can consist of one or more fields, if it has more than one field it means that during extraction one must collect the different fields and put them in their original location.
4. Convert the auxiliary image from 24 bpp to a binary 1 bpp image (402). The auxiliary image was combined into main image as a 24 bpp, one must convert it back to 1 bpp image in order to apply the binary decoding algorithm.
5. Reveal the embedded data fields from the binary image (403). For authentication purposes one uses the L identification code. In the encoder one has embedded the M′ sequence, in which the first L−1 bytes are K{0 . . . L−1}=L{0 . . . L−1} XOR M{0 . . . L−1}, to get back the first L−1 byte of M one must use M{0 . . . L−1}=M′{0 . . . L−1} and M′{L . . . M−1}=M{L . . . M−1}. Clients with different L identification code will fail, to reconstruct M{0 . . . L−1} and therefore will fail in authentication decision and revealing of main hidden data.
6. Identity verification (412). The identification code is an L byte long code that is associated with the client and/or the card, and is unique. This code is added to the embedded code to distinguish between clients and/or cards. L may for instance be a MAC address, serial ID, or combination thereof.
7. Reveal data from second embedding, using unscrambled quantization (404). One reads the quantized. DCT coefficients, from which one extracts the relevant bits that carries the embedded data. The uniform distribution random function is applied to decide what piece of data they represent (see step 11 of the encoding sequence above). This function returns an entry value for a table such as Table 2 (step 11 above) allowing one to interpret the code as a ‘1’ or ‘0’.
8. Reverse shuffling and reveal main error correcting code data, using data from second embedding algorithm (405). The encoder algorithm uses the first L bytes of sequence M, to bit by bit randomly shuffle the data before the JPEG embedding algorithm, thus to decode one uses here the same first L bytes of sequence M to apply a reverse bit by bit random shuffling.
9. Reveal data using error correcting code algorithm (406). The data received from block 405 above is the data coded by an error correcting code (as explained in step 4 of the encoding sequence above), one applies here the decoder of the error correcting code algorithm. The data decocted is the M bytes of M sequence and the main hidden data.
10. Make decisions using main data and auxiliary data fields (407). If the two M sequences you received from block 3 and 7 above are the same, continue to use the application with the revealed main hidden data.

### Types of Cards

Various types of cards may be implemented with the system described above including admission tickets, entry cards, membership cards, discount cards, coupons, debit cards, food stamps, ecash, scratch cards, and credit cards.

### Scratch Cards

As will be appreciated, more than one scratch card type may be implemented by the IBP, including multiple use cards and several types of single use cards. The card behavior is determined by the card type as follows:

### Multiple Usage Cards

These cards can be used by several users, for instance being forwarded by email or transferred by any other data transfer method. This process may occur multiple times, until an optional expiration condition is fulfilled. Thus a counter may be implemented by the method of the invention, with count information being stored either in the hidden card information, on a server, or elsewhere.

### Single Use Multiple User Cards

In this embodiment of the invention, a card can be used only once by each user, but multiple users may use a given card.

### Single Use Single User Cards

The single-use single-user cards are limited to use by its (single) owner, which will generally be the user that requested or got it originally from the system. In some embodiments of the invention, verification is carried out by the device application, for example while loading the card. In this case the user knows immediately whether card is valid or not.

In addition to the various usage and owner possibilities mentioned above, forwarding options may be implemented as described hereinafter:

### Forwarding

In some embodiments of the invention, forwarding of scratch cards (e.g. from user to user) is not allowed. This is accomplished by means of the authentication step requiring a particular L-code (based on MAC address or the like), whereby any user other than the intended recipient will not be able to reveal the hidden contents of the card.

In other embodiments of the invention, forwarding of scratch cards is allowed. In these cases several possibilities are within provision of the invention, including direct and indirect forwarding as described below.

Direct Forwarding—In this variation of the method of the invention, the user gets the actual scratch card from a friend or other forwarding party, via email or other data transfer method. The device application identifies that this is a forwarded scratch card, and extracts the associated data accordingly, in light of the information that this is a forwarded scratch card. The forwarding information, possibly including sender, recipient, number of forwards, and the like may be stored within the card itself, either in hidden or revealed data portions thereof, and/or on a server, and/or elsewhere.

Indirect Forwarding—In this embodiment of the invention, the user receives a link and issues a request based on link parameters. This link contains, for example, a pointer to a scratch card in a centralized database which is managed by a web service or other entity. The user may then log in and download a card image produced by the service.

### Scratch Card Validation

It is within provision of the invention to provide a validation step allowing the system operator to verify the identity of a given scratch card holder or other entity attempting to redeem a scratch card. This validation step is implemented in one embodiment of the invention as follows:

Each time an image is loaded, a secure database is updated. When a scratch card is loaded by a local device application (LDA) for the first time, the following is validated:
This image is a scratch card
This image produced by a valid scratch cards producer
This image is valid scratch card for use for this user

As part of the LDA interface, a ‘redeem’ button may be implemented. When the user taps this “Redeem” button and chooses a redemption method (if more than one is allowed), the following validation checks are done by the device application:
Scratch card is owned by user
Expiration date
Whether the card has already been redeemed, and if so how many times.

The aforementioned checks can be performed locally (on the local device), remotely (e.g. on a server), or both. Then, if possible, the scratch card is replaced with a new one. If not, the secured DB is updated.

To complete the validation process the scratch card unique ID, which may be composed of several parameters, is transferred through the network to the server for validation in the centralized scratch card database (see Redemption step below). This occurs for example at the point-of-sale, using one or more communication and verification methods such as barcode scanning, near-field communication such as RFID, Bluetooth, wireless lan, SMS, or other means as will be obvious to one skilled in the art.

It is within provision of the invention that the scratch cards can carry commercial data. This data is part of the card's, associated data. Commercial data can appear on the scratch card in two ways:

Data is shown on the card's front side (to all users, always).

Data is hidden, and functions as a “secondary scratch card”—namely, data is revealed after ‘scratching’ the hidden area or otherwise revealing the hidden data by a user that is not the original ‘owner’. In this case the revealed data may be different than the data revealed to the original ‘owner’ user.

### Local Device Application

In some embodiments of the invention, a local device application is installed on the user's device, running locally and in communication with a local secure database. Each device has a unique application or copy of the application, which may be vendor dependent.

Using the device application, the user can register with the scratch card service, load a scratch card from remote or local storage on the device or Flash memory), and store a scratch card to local or remote storage.

### User Interface for Scratching Action

The user interface for the local device application will in some embodiments have provision for:
Saving the scratched card to local storage.
Enabling redemption of the prize specified on the scratched card, in the scratched area.
Scratch card authentication, single or multiple.
Forwarding the derived (secondary scratch card) promotion cards to friends

### Scratch Card Service

In addition to the local device application, a remote server-based application is provided by the invention. This constitutes, in some embodiments, a web service to manage the scratch card life cycle, which consists of design, management and dispatch. The web service will in some embodiments manage a database of registered users.

In some embodiments of the invention, the user has to go to point-of-sale with the device to redeem a winning scratch card. In some embodiments of the invention, redemption requires use of the device application (for local authentication, depending on the scratch card type). In this case, one or more scratch card's data (from the card's associated data fields) are transferred to identify and authenticate the card.

It is within provision of the invention to use several redemption methods, including but not limited to:
Barcode scanning
NFC (Near Field Communication) channel
Secure SMS

The redemption method for a given scratch card is defined by the producer of the scratch card at the time of its production or, in some embodiments, afterwards.

It is within provision, of the invention that a single scratch card can support one or more redemption method.

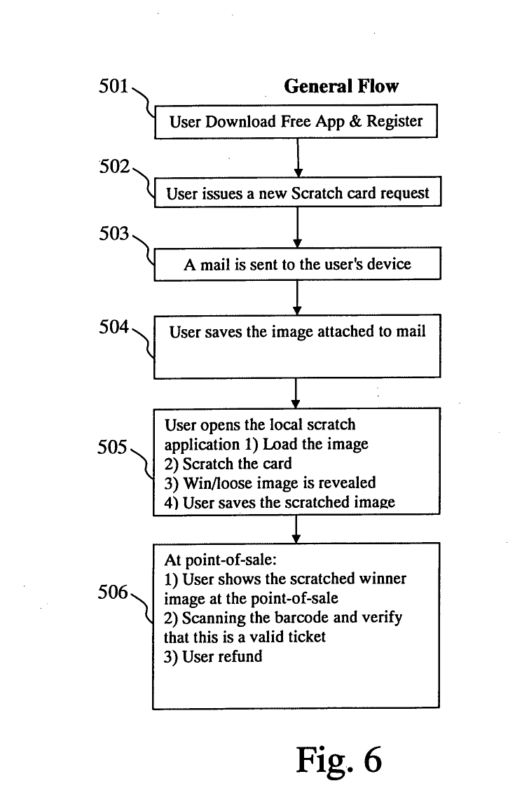

To illustrate the steps involved in use of the invention, reference is made to the flow chart of FIG. 6. As shown in the figure, in a possible embodiment of the invention the process is started when a user downloads an application from a server, and undergoes a registration step 501. Subsequently the user may issue a request for a new scratch card 502, whereupon a mail or other data transmission is sent to the user's device 503. The user can then save the transmitted information 504, either to a local or remote location. Once the data object of step 504 is saved, the user may then open the local application, load the image (with hidden information still hidden), perform a decrypting operation by (for instance) using a wiping or scratching not over a part of an image that appears to have a covering over it, after which the hidden information is revealed. This may take the form (for instance) of a win/lose indicator. The revealed image and/or information may then be revealed.

Once a user has obtained card having some redeemable value, the user may redeem this value for instance at a point of sale. The card is verified by means of bar code, passcode, biometric ID, or other means as will be obvious to one skilled in the art. Once verified, the user may then be given or transferred the item(s) won, for instance by transfer of money to a user's account, by giving the user a won object, or the like.

### Registration

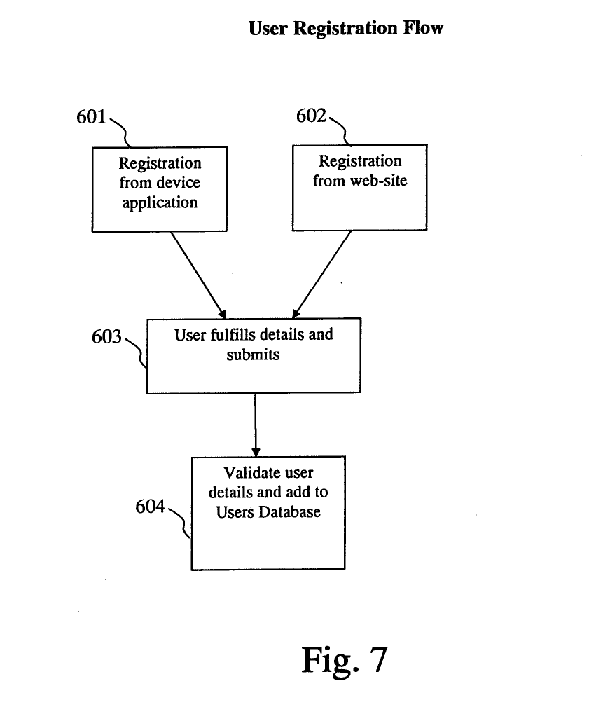

The user will generally have to undergo a registration step as shown in FIG. 7. The registration may take place at the level of the device application 601 or remotely over a website 602. The registration consists of a set of details submitted by the user 603. These details are validated, and then aided to a user database 604.

If a user changes his/her device, an update of details should be performed to once again associate the user ID information and device identification information (such as MAC address).

### Card Request

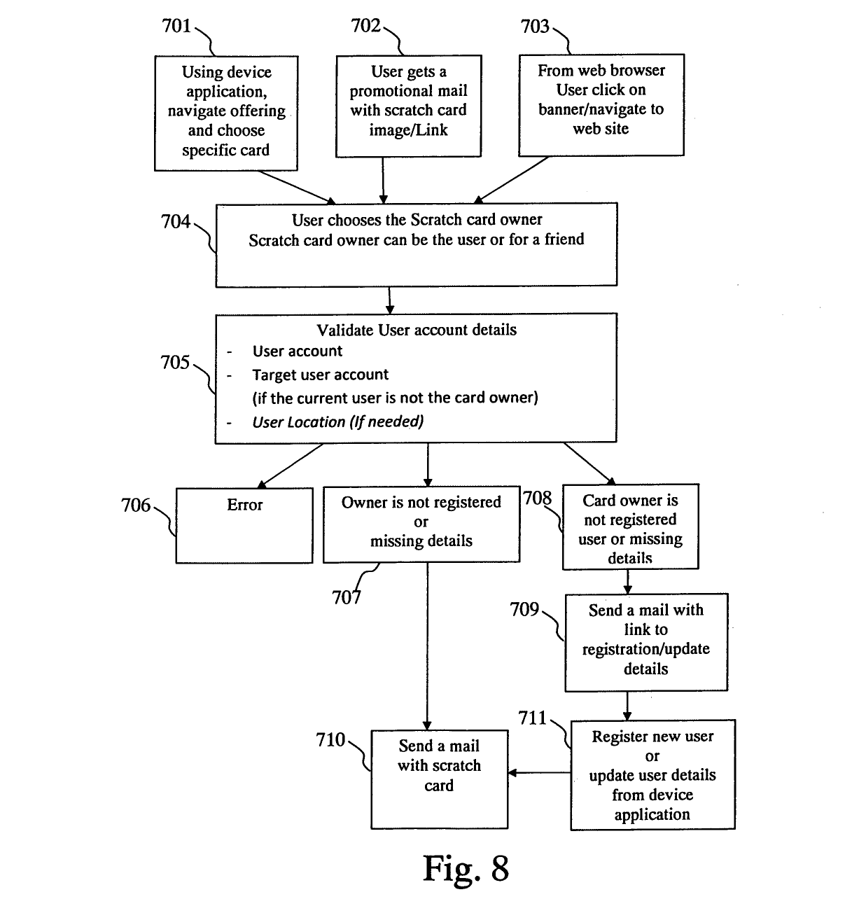

The flow chart of FIG. 8 illustrates an example of a sequence of events that occur during user request of a new card. Using the device application, a user may choose a type of card or specific card to receive or send to another user 701. Alternatively, the receiving user then receives a promotional mail 702 with the scratch card itself or a link thereto. A third option is through a web browser, where a user can navigate to choose a card to receive 703. The user then chooses a recipient 704. The user account is validated, as well as the recipient account if different froth the user, and user location is determined if needed 705. If any of these details are incorrect or in error this is indicated 706. If the owner is not registered or details are missing 707, a further error may be generated. If the card owner is not registered or details are missing 708, a mail requesting the missing details is sent 709. Then the user updates or enters new details to the device application 711, after which the scratch card may be set 710.

### Revealing Hidden Information

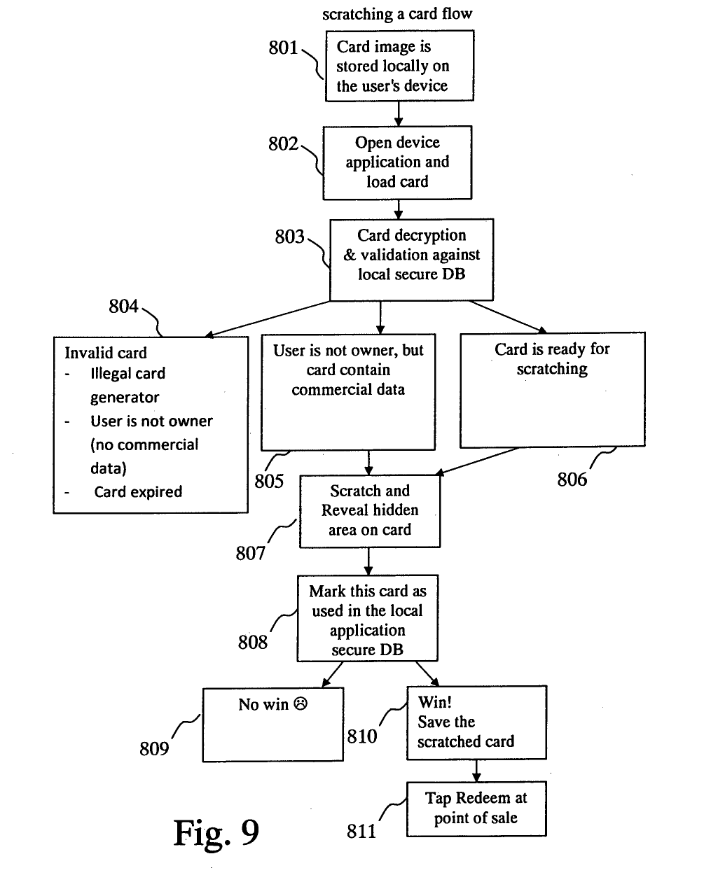

One possible sequence of events involved in revealing the hidden information is detailed in the flow chart of FIG. 9. A card stored locally on the user's device 801 is loaded and opened 802. The card is then decrypted and validated against the secure database 803. A reject procedure is undertaken in the case of verification failure, which may be due to illegal card generation, invalid owner state, or expired card state. If the user is not the owner but the card contains commercial data, this case may be allowed 805. Finally a valid verified card may be ready for revealing the hidden information 806. The hidden information is revealed in these litter two cases by some action on the user's part 807 such as making a scratching motion over the card image on a touch screen. This card is subsequently marked as used in the secure database 808. If the card is not a winning card this is indicated 809, while if the card is a winning card the card may be saved 810. Holders of winning cards may redeem the cards at a point of sale 811.

### Redemption

The user may redeem a winning card as follows, with reference to FIG. 9. The user having a winning card stored locally 901 may open and load the card 902. A button labeled ‘redeem’ or the like is pressed 903, whereupon the card is verified against a local secure card database 904. If the card. ID is invalid 905, an appropriate error message is generated 906. If the card is valid a redemption method selection is given; for instance these methods may be display of barcode 907, near field communication (NFC) 908, SMS (909) or others not shown. Once the redemption method is invoked, the card is validated against a central database 910. If invalid, the card is rejected 911. If valid, the user receives the goods/services appropriate 912.

### Validation

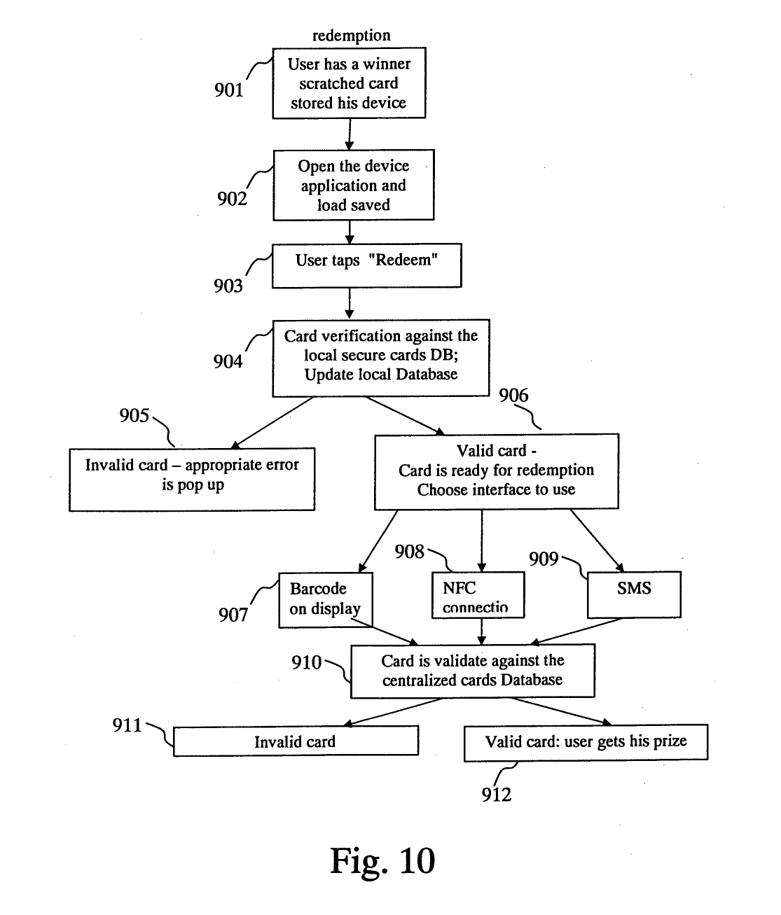

The validation step of the invention is shown in the flow chart of FIG. 10. The user attempts a redemption at point of sale 1001. The registration information is sent to the scratch card management server 1002, and from there entered into a centralized scratch card database 1003. Once registered, a message indicating verification or lack thereof is sent to the management server 1002 and from thence to the point of sale 1001.

### Implementation

It is within provision of the invention that the method be carried out by means of software running on dedicated machines. It is further within provision of the invention that the method be The algorithm can be implemented in Hardware (FPGA, ASIC, or the like.)

1-16. (canceled)

17. A computer-implemented method performed by a computerized device, comprising:
obtaining a unique identifier L;
obtaining a first dataset Iₘₐᵢₙ having a bit depth B;
obtaining a second dataset Iₐᵤₓ having a bit depth A, wherein A is smaller than B;
obtaining a third dataset to be embedded D;
obtaining a fourth dataset to be embedded M;
generating M′ from M and L, by concatenating XOR(L, M₀ . . . M_{length(L)-1}) and M_{length(L)} . . . M_{length(M)};
embedding M′ into Iₐᵤₓ to form I_{aux′} using the first embedding function;
increasing a bit depth of I_{aux′} to a bit depth B;
concatenating M with D to form X=M+D; and
shuffling X using a shuffling function s with L as a shuffling parameter to form S=s(L,X),
inserting I_{aux′} into Iₘₐᵢₙ to form combined dataset _{Imain+aux}, and
embedding S into Iₘₐᵢₙ₊ₐᵤₓ to form I′ₘₐᵢₙ₊ₐᵤₓ using a second embedding function,
wherein M cannot be derived from I′main+aux without L, and wherein M is not corrupted by said second embedding function due to a difference in bit depth between A and B.

18. The method of claim 17, wherein:
L is an identifier associated with a mobile device,
Iₘₐᵢₙ is a first image,
Iₐᵤₓ is a second image,
D is data to be embedded in the first image, and
M is a random sequence,
thereby embedding data within the second image and embedding the second image within the first image.

19. The method of claim 18, wherein embedding data within an image comprises replacing least significant bits of at least one of the discrete cosine transform (DCT) coefficients of the first image or the second image.

20. The method of claim 17, wherein D represents a card whose value is embedded within a first image having a first color depth, and the first image is merged into a color image having a second color depth larger than the first color depth, such that the D is not corrupted by the embedding algorithm.

21. The method of claim 20, wherein the color image with the first image merged therein is to be displayed on a computerized device.

22. The method of claim 17, further comprising a step of recoding said second dataset with an error correcting code operating on S before said step of shuffling said S.

23. The method of claim 17, wherein the third dataset represents an object selected from the group consisting of: an admission ticket, an entry card, a membership card, a discount card, a coupon, a debit card, a food stamp, e-cash, and a credit card.

24. The method of claim 17, wherein the second dataset is a binary dataset.

25. The method of claim 17, wherein said first dataset is a 24 bits per pixel dataset.

26. A computer-implemented method for revealing a hidden image to a client, the method performed by a computerized device, the method comprising:
initiating receipt of a digital scratch card;
sending a unique identifier from said client to a server;
receiving an image from said server;
verifying said image using the unique identifier; and
revealing said hidden image.

27. A method performed by a computerized device, the method comprising:
selecting an auxiliary region from a main image;
extracting a first dataset of information steganographically embedded in the
auxiliary region using a unique identifier using a first extraction method;
extracting a second dataset of information steganographically embedded in said main image using a second extraction method;
performing a reverse shuffle on said second dataset to form unshuffled data;
performing the inverse of an error correcting code on said unshuffled data to form unencoded data; and
revealing said unencoded data.

28. The method of claim 27, wherein said auxiliary region is a binary image.

29. The method of claim 28, further comprising a step of converting the binary image to a higher bit depth image.

30. The method of claim 27, wherein said first and second extraction methods extract information from the least significant bits of the discrete cosine transforms of said datasets.

31. The method of claim 27, wherein said auxiliary region is a binary image/dataset.

32. The method of claim 27, wherein said main image is a 24 bit per pixel image.

33. The method of claim 27, wherein said image represents an object selected from the group consisting of: an admission ticket, an entry card, a membership card, a discount card, a coupon, a debit card, a food stamp, e-cash, and a credit card.
